(19) United States
(12) Patent Application Publication
(10) Pub. No.: US 2005/0150321 A1
(43) Pub. Date: Jul. 14, 2005

(54) Adjustable structure of bicycle handlebar

(75) Inventor: Hsueh-Sen Liao, Hsin-Chu Hsien (TW)

Correspondence Address: TROXELL LAW OFFICE PLLC;SUITE 1404, 5205 LEESBURG PIKE, FALLS CHURCH, VA, 22041, US

(73) Assignee: Hsin Lung Accessories Co., Ltd.

(21) Appl. No.: 10/756,278

(22) Filed: Jan. 14, 2004

(51) Int. Cl. B62K 21/12

(52) U.S. Cl. 74/551.1

(57) ABSTRACT

An adjustable structure of bicycle handlebar comprising a locking connector and a connecting tube to connect the stem and the handlebar together; the locking connector and the connecting tube are connected with a first wedge and a second wedge locked with a threaded bolt; a teeth centered with the bolt in radiating shape each is installed on the junction of the first and the second wedge, a single threaded bolt to connect the locking connector and the connecting that can adjust the angle of the handlebar.

### BACKGROUND OF THE INVENTION

I. Field of the Invention

This invention relates generally to a handlebar and, more specifically, to an adjustable structure of bicycle handlebar that offers more stable handlebar and stem connection mechanism, and more convenient to adjust the angle of handlebar.

II. Description of the Prior Art

Heretofore, it is known that the structure of the bicycle handlebar adjustable structure shown in FIG. 1, a locking connector 30 and a connecting tube 40 connect the handlebar 20 and the stem 10 together, the locking connector 30 is in hoop shape with a wrapping hole 31 in center to clamp the stem 10, a wedge 32 stretches out from the locking connector 30; a gap 34 stretches from middle of the wedge 32 to a wrapping hole 31, a first wedge 33 installed opposite to the wedge 32 is on the locking connector 30, one end of the connecting tube 40 connects to the handlebar 20, the other end is a second wedge 41 clamping the first wedge 33, a bolt 50 interlocks the first and the second wedges 33, 41 to connect the locking connector 30 and the connecting tube 40, the bolts 50 lock the locking connector 30 and the stem 10.

The angle adjustment of the handlebar 20 is on the connection on the first and the second wedges 33, 41; a through hole 71 each is on the first and the second wedges 33, 41 respectively for a bolt 50 to insert, two collar 51 are installed externally to the through hole 71 of the second wedge 41, one of the collar 51 has threads 72 to screw with the bolt 50, a pair of teeth 73 are installed on the junction of the first and the second wedges 33, 41; when the bolt 50 is screwed tight, the pressure from the collars 51 makes the first and the second wedges 33, 41 get close and have the locking connector 30 further compress the wrapping hole 31 to lock the locking connector 30 and the stem 10 firmly; the function of the teeth 73 stick the first and the second wedges 33, 41 stably and fix the angle between the locking connector 30 and the connecting tube 40 to adjust the angle of the handlebar 20.

The prior art described above needs at least two locking operations to connect the handlebar 20 and the stem 10, the labor and manufacturing cost is high; in real application, the tedious operation will cause inconvenience to adjust the horizontal and vertical angles of the handlebar 20.

### SUMMARY OF THE INVENTION

It is therefore a primary object of the invention to provide an adjustable structure of bicycle handlebar that can adjust the angle of the handlebar with a single bolt.

In order to achieve the objective set forth, an adjustable structure of bicycle handlebar in accordance with the present invention comprises a locking connector and a connecting tube to connect the stem and the handlebar together; the locking connector is in hoop shape with a wrapping hole in center to clamp the stem, a first wedge stretches out from the locking connector; a connecting tube with one end connects to the handlebar, a second wedge is one the other end of the connecting tube, the second wedge clamps the first wedge, a bolt interlocks between the first wedge and the second wedge, a gap stretches from the middle of the first wedge to a wrapping hole that locks the stem with the bolt, a teeth centered with the bolt in radiating shape each is installed on the junction of the first and the second wedge.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an assembly view of the prior art;

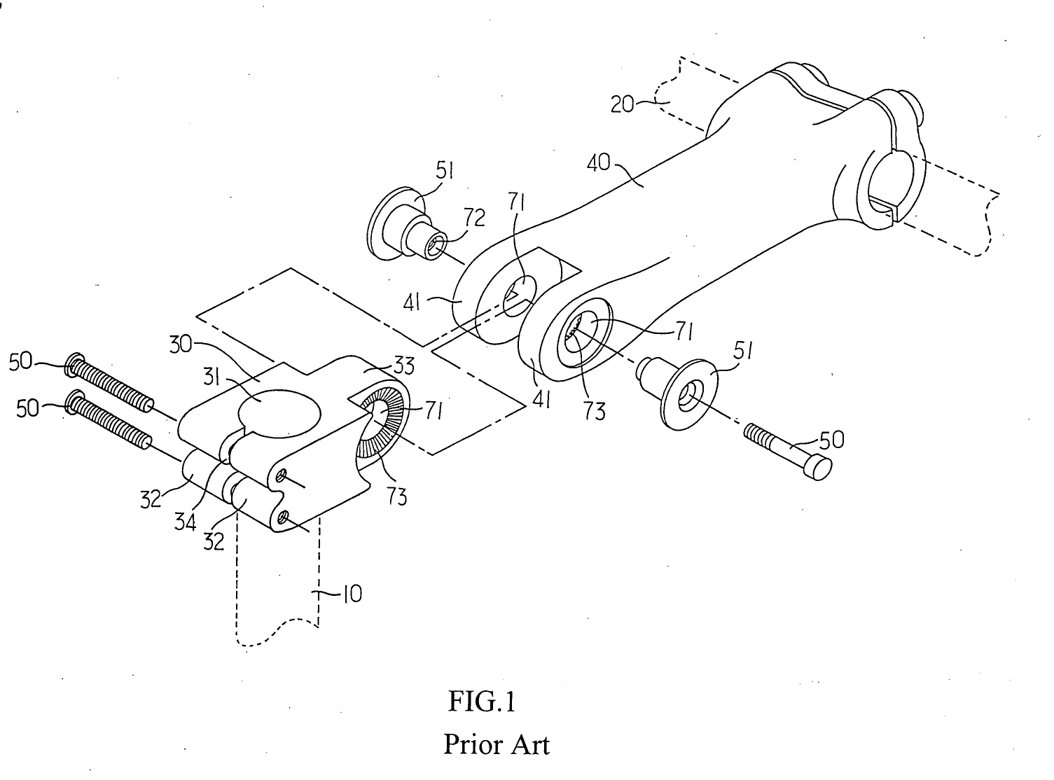

FIG. 2 is a perspective view of an application of the present invention;

FIG. 3 is an assembly view of an application of the present invention;

FIG. 4 is a cross-sectional view of an application of the present invention;

FIG. 5 is an assembly view of another application of the present invention;

FIG. 6 is an assembly view of the third application of the present invention.

### DESCRIPTION OF THE PREFERRED EMBODIMENT

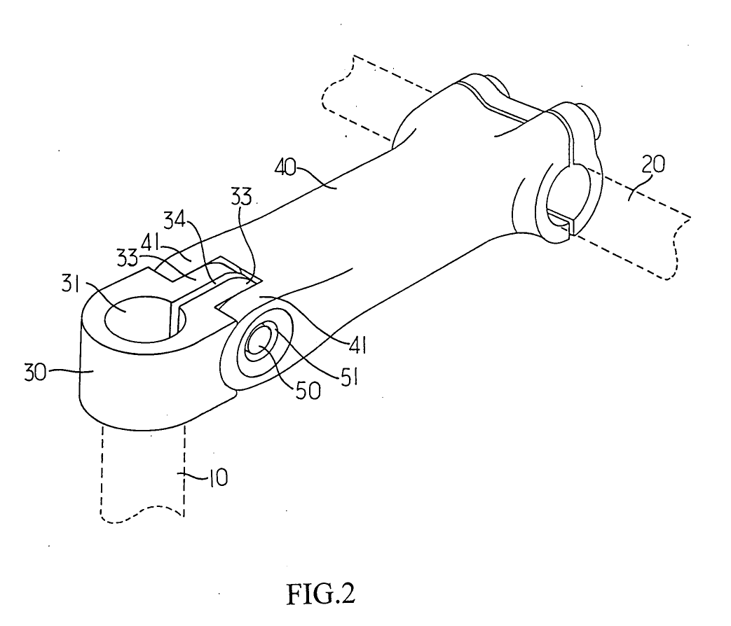

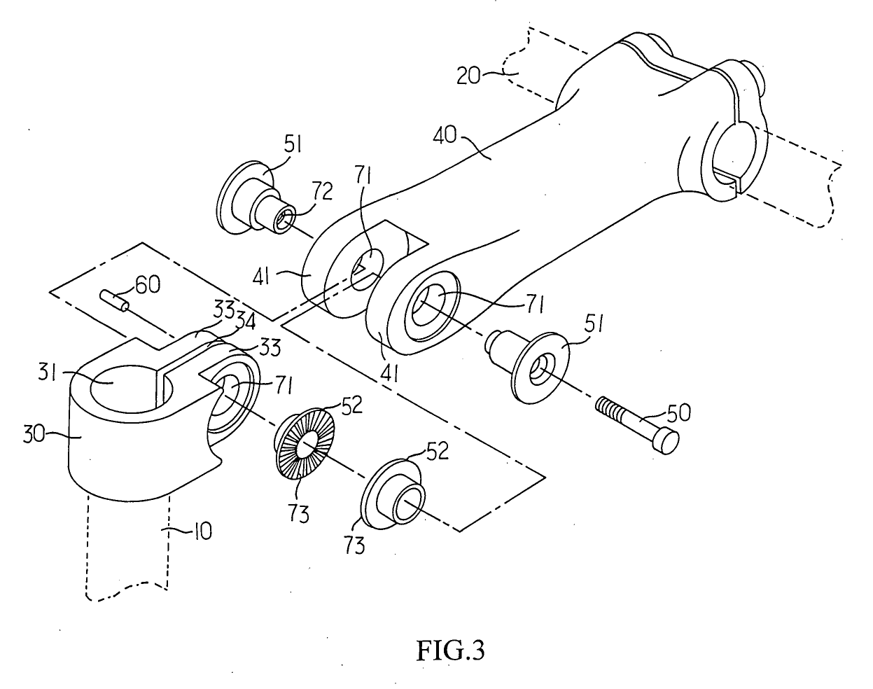

Referring to FIG. 2 and FIG. 3, the present invention is composed of a locking connector 30 and a connecting tube 40 to connect the stem 10 and the handlebar 20 together; the locking connector 30 is in hoop shape with a wrapping hole 31 in center to clamp the stem 10, a first wedge 33 stretches out from the locking connector 30; one end of the connecting tube 40 connects to the handlebar 20, a second wedge 41 is one the other end of the connecting tube 40, the second wedge 41 clamps the first wedge 33, a bolt 50 interlocks between the first wedge 33 and the second wedge 41.

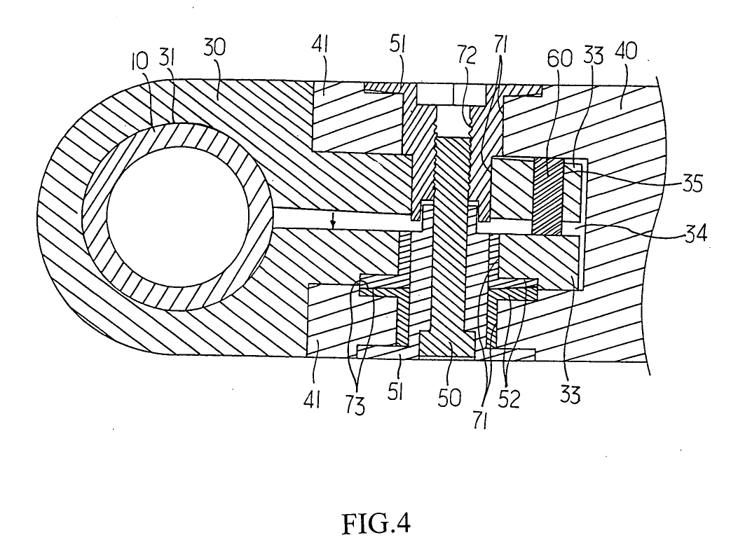

Referring to FIG. 4, a gap 34 stretches from the middle of the first wedge 33 to a wrapping hole 31 that locks the stem 10 with the bolt 50; a teeth 73 centered with the bolt 50 in radiating shape each is installed on the junction of the first and the second wedge 33, 41; in the application example shown in FIG. 2 to FIG. 4, the second wedge 41 clamps externally the first wedge 33, a pair of through hole 71 are on the first and the second wedge 33, 41 for the bolt 50 to pass through; a pair of collars 51 are installed externally to the through hole 71 of the second wedge 41, one of the collar 51 has threads for the bolt 50 to connect; a pair of washer 52 with teeth 73 on surface are on the junction of the first and the second wedge 33, 41 to connect the locking connector 30 and the connecting tube 40 with a single bolt 50 and have the handlebar 20 with the angle adjustable structure.

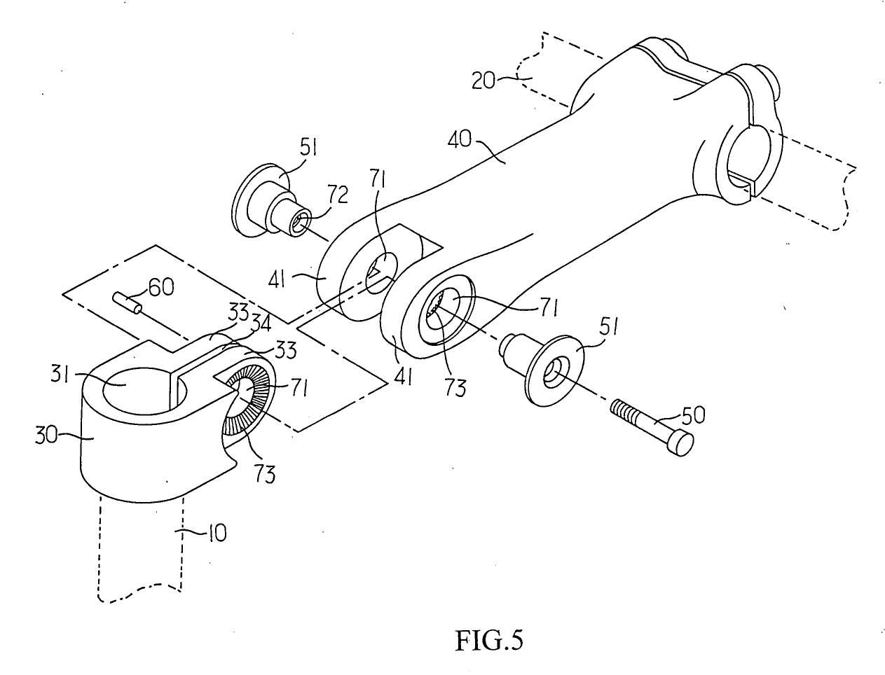

Referring to FIG. 5, the teeth 73 can also be in the surface of the first and the second wedge 33, 41 to save the installation of washer 52. Referring to FIG. 3 and FIG. 4, a stopper 60 corresponding to the bolt 50 is installed on the end of the gap 34 of the first wedge 33 of the locking connector 30, a positioning hole 35 corresponding to the bolt 50 is installed on the end of first wedge 33, the stopper 60 is in stick shape and is inserted into the positioning hole 35, one end of the stopper 60 is inserted into the gap 34 of the first wedge 34; when the bolt 50 is fastened tight, the end of the first wedge 33 corresponding to the bolt 50 is propped up by the stopper 60 to have the pressure from the bolt 50 move to the wrapping hole 31 of the first wedge 33, the wrapping hole 31 squeezes the stem firmly.

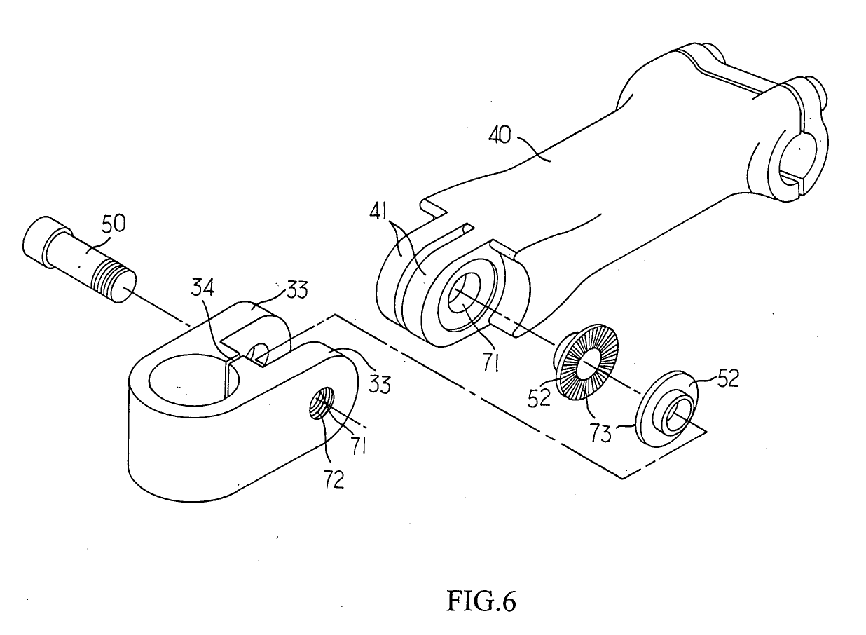

Referring to FIG. 6, another application example of the present invention, the first wedge 33 clamps the second wedge 41; a pair of through holes 71 each are on the first and the second wedge 33, 41 for the bolt 50 to insert, one of the through hole 71 of the first wedge 33 has threads for the bolt 50 to screw that connects the connecting tube 40 and the locking connector 30 together; a pair of washers 52 with teeth 73 are on the junctions of the first and the second wedge 33, 41, the combination can firmly fasten the first and the second wedge 33, 41, the angle of handlebar can also be fixed.

While a preferred embodiment of the invention has been shown and described in detail, it will be readily understood and appreciated that numerous omissions, changes and additions may be made without departing from the spirit and scope of the invention.

1. An adjustable structure of bicycle handlebar comprising:
a locking connector is in hoop shape with a wrapping hole in center to clamp the stem, a first wedge stretches out from said locking connector;
a connecting tube with one end connects to the handlebar, a second wedge is one the other end of said connecting tube, said second wedge clamps said first wedge, a bolt interlocks between said first wedge and said second wedge, a gap stretches from the middle of said first wedge to a wrapping hole that locks the stem with said bolt, a teeth centered with said bolt in radiating shape each is installed on the junction of said first and said second wedge, single said bolt locks said locking connector and said connecting tube firmly and adjusts the angle of the handlebar.

2. The adjustable structure of bicycle handlebar recited in claim 1, wherein said second wedge clamps externally said first wedge.

3. The adjustable structure of bicycle handlebar recited in claim 1, wherein said first wedge clamps externally said second wedge.

4. The adjustable structure of bicycle handlebar recited in claim 2, wherein each said teeth is installed on the junction of said first and said second wedge.

5. The adjustable structure of bicycle handlebar recited in claim 2, wherein a stopper corresponding to said bolt is installed on the end of said gap of said first wedge, said bolt has threads, when said bolt is fastened tight, the end of said first wedge corresponding to said bolt is propped up by said stopper to have the pressure from said bolt move to said wrapping hole of said first wedge, said wrapping hole squeezes the stem firmly.

6. The adjustable structure of bicycle handlebar recited in claim 5, wherein a positioning hole corresponding to said bolt is installed on the end said first wedge, said stopper is in stick shape and is inserted into said positioning hole, one end of said stopper is inserted into said gap of said first wedge.

7. The adjustable structure of bicycle handlebar recited in claim 2, wherein a pair of through holes each are on said first and said second wedge for said bolt to insert, said bolt has threads, a pair of collar are installed externally to said through hole of said second wedge, one of said collar has threads internally for said bolt to screw.

8. The adjustable structure of bicycle handlebar recited in claim 2, wherein a pair of through holes each are on said first and said second wedge for said bolt to insert, said bolt has threads, a pair of collars are installed externally to said through hole of said second wedge, one of said collar has threads internally for said bolt to screw, a pair of washers with teeth are on the junctions of said first and said second wedge.

9. The adjustable structure of bicycle handlebar recited in claim 3, wherein a pair of through holes each are on said first and said second wedge for said bolt to insert, said bolt has threads, one of said through hole of said first wedge has threads for said bolt to screw.

10. The adjustable structure of bicycle handlebar recited in claim 3, wherein a pair of through holes each are on said first and said second wedge for said bolt to insert, said bolt has threads, one of said through hole has threads internally for said bolt to screw, a pair of washers with teeth are on the junctions of said first and said second wedge.

11. The adjustable structure of bicycle handlebar recited in claim 3, wherein each said teeth is installed on the junction of said first and said second wedge.
